(19) United States
(12) Patent Application Publication
(10) Pub. No.: US 2008/0235636 A1
(43) Pub. Date: Sep. 25, 2008

(54) Identifying Radiation-Induced Inversions

(76) Inventor: David A. Kamp, Monument, CO (US)

Correspondence Address: HANES & SCHUTZ, LLC, 102 SOUTH TEJON ST., SUITE 800, COLORADO SPRINGS, CO, 80903, US

(21) Appl. No.: 11/690,607

(22) Filed: Mar. 23, 2007

(51) Int. Cl. G06F 17/50

(52) U.S. Cl. 716/4; 716/11

(57) ABSTRACT

A semiconductor layout design analyzer alerts a user of areas in a semiconductor layout design that may be candidates for radiation induced inversion. The analyzer includes means for gathering information, means for identifying, and means for alerting the user. The means for gathering gathers, from the layout design, placement information for thick oxide, low-doped p-type single crystal silicon, and n-type silicon. The means for identifying identifies, in the layout design, thick oxide overlaying low-doped p-type single crystal silicon and abutting n-type silicon. The means for alerting the user alerts the user of the identified areas of thick oxide.

### BACKGROUND OF THE INVENTION

Semiconductor devices are susceptible to inversions when used in environments with high levels of ionizing radiation. These radiation induced inversions produce unstable results and may cause permanent damage to the semiconductor devices. The inversions occur when the radiation creates parasitic conducting paths, allowing leakage current to flow from the drain diffusion to the source diffusion, from the drain or source of one transistor to the drain or source of another, or from an n-well to the drain or source of a transistor. Identification and blocking of these leakage paths are critical to the proper operation of a radiation hardened semiconductor device design.

Furthermore, radiation-induced inversions may create parasitic capacitance in a semiconductor device. Parasitic capacitance occurs when radiation induced inversion takes place in a region of thick oxide that is much larger than an abutting n-type silicon. Eliminating occurrences of parasitic capacitance is also of significant importance to the proper operation of a radiation hardened semiconductor device design.

### DESCRIPTION OF THE DRAWINGS

FIG. 1 is a cross-sectional diagram representing an example of a semiconductor design layout having areas, according to the present invention, that may be candidates for radiation induced inversion.

FIG. 2 is a block diagram illustrating one embodiment of the present invention semiconductor layout design analyzer.

FIG. 3 is a flow chart illustrating one embodiment of the present invention method for alerting a user of a design analyzer of areas in a semiconductor layout design that may be candidates for radiation induced inversion.

### DETAILED DESCRIPTION OF THE INVENTION

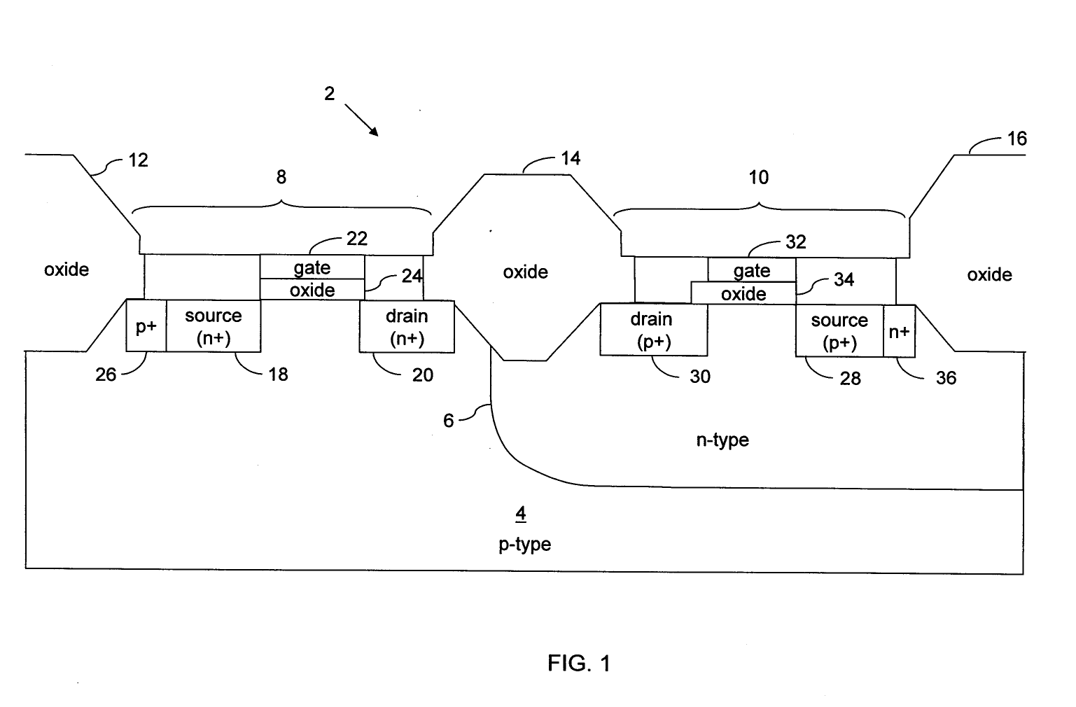

Illustrated in FIG. 1 is a cross-section of an example of a semiconductor design layout 2. Semiconductor design layout 2 has an area of p-type silicon 4 into which is inlaid an n-type well 6. Two transistors 8, 10 are represented in design layout 2. Thick layers of field oxide 12, 14, and 16 isolate each transistor 8, 10 from other components of design layout 2. Each transistor 8, 10 has a source 18, 28, a drain 20, 30, a gate 22, 32, an oxide layer 24, 34, and a contact 26, 36.

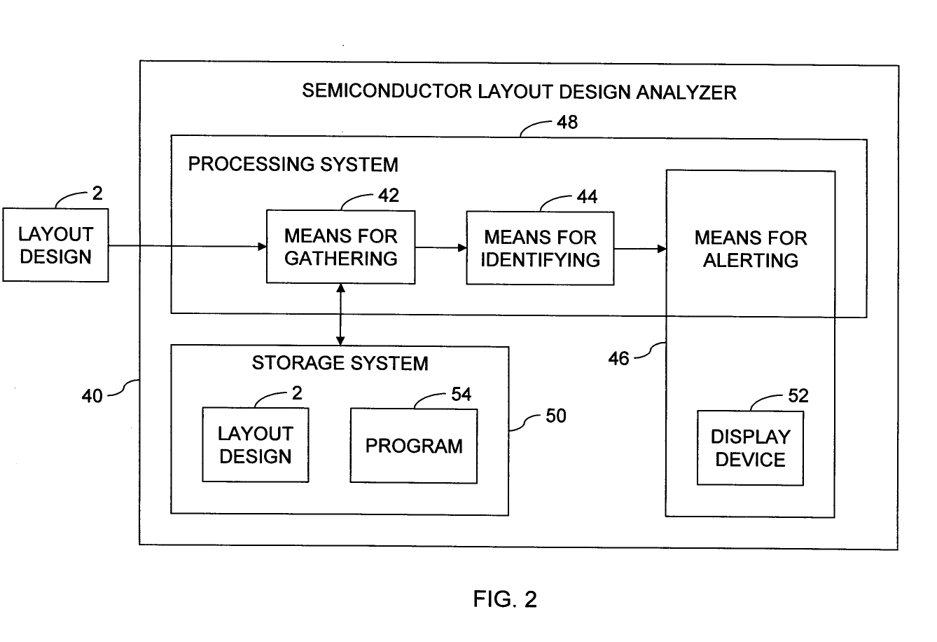

FIG. 2 shows a block diagram illustrating one embodiment of the a semiconductor layout design analyzer 40 for alerting a user of areas in a semiconductor layout design 2 that may be candidates for radiation induced inversion. Semiconductor layout design analyzer 40 includes means 42 for gathering placement information, means 44 for identifying specific locations of thick oxide, and means 46 for alerting the user.

Means 42 for gathering placement information is any means for gathering placement information, from layout design 2, for thick oxide, low-doped p-type single crystal silicon, and n-type silicon. The n-type silicon may include an n-type well, an n-type source, or an n-type drain. In one embodiment, the means for gathering 42 further includes means for gathering, from layout design 2, size information for thick oxide and n-type silicon.

In one embodiment, semiconductor layout design analyzer 40 includes a processing system 48 of a computer or of the type used in computers and the means 42 for gathering is embodied in the processing system 48. Processing system 48 includes any combination of hardware and executable code configured to gather placement information, from layout design 2, for thick oxide, low-doped p-type single crystal silicon, and n-type silicon. Processing system 48 may also gather size information for thick oxide and n-type silicon.

In one embodiment, information about layout design 2 is gathered from sources external to semiconductor layout design analyzer 40. In another embodiment, semiconductor layout design analyzer 40 includes a storage system 50 and information about layout design 2 is gathered from a storage system 50.

Storage system 50 is any device or system configured to store data or executable code. Storage system 50 may also be a program storage system tangibly embodying a program 54, applet, or instructions executable by processing system 48 for performing the method steps of the present invention executable by processing system 48. Storage system 50 may be any type of storage media such as magnetic, optical, or electronic storage media.

Storage system 50 is illustrated in FIG. 2 as a single device. Alternatively, storage system 50 may include more than one device. Furthermore, each device of storage system 50 may be embodied in a different media type. For example, one device of storage system 50 may be a magnetic storage media while another device of storage system 50 is an electronic storage media.

Means 44 for identifying specific locations of thick oxide is any means for identifying, in layout design 2, thick oxide overlaying low-doped p-type single crystal silicon and abutting n-type silicon. In one embodiment, the size of the identified thick oxide is larger than the abutting n-type silicon by a determined amount. In another embodiment, means 44 for identifying includes means for identifying thick oxide abutting two or more n-type regions.

In one embodiment, means 44 for identifying specific locations of thick oxide is embodied in the processing system 48. Processing system 48 includes any combination of hardware and executable code configured to identify, in layout design 2, thick oxide overlaying low-doped p-type single crystal silicon and abutting n-type silicon. Processing system 48 may also identify thick oxide abutting two or more n-type regions. Processing system 48 may also identify thick oxide larger than the abutting n-type silicon by a determined amount.

Means 46 for alerting the user is any means for alerting the user of the identified areas of thick oxide. In one embodiment, means 46 for alerting the user includes a display device 52 and means for displaying placement information of the identified thick oxide. For example, the means for alerting may display coordinates of the identified thick oxide on display device 52.

In an alternative embodiment, means 46 for alerting the user includes means for displaying, on display device 52, a visual representation of layout design 2, and means for marking on the visual representation the identified areas of thick oxide.

In one embodiment, means 46 for alerting the user is embodied in the processing system 48. Processing system 48 includes any combination of hardware and executable code configured to alert the user of the identified areas of thick oxide. Processing system 48 may also display placement information of the identified thick oxide. Processing system 48 may also display, on display device 52, a visual representation of layout design 2, and mark on the visual representation the identified areas of thick oxide.

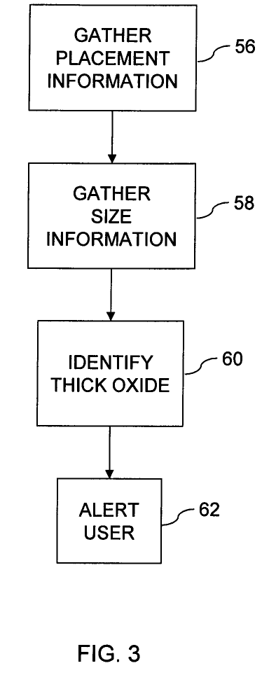

FIG. 3 is a flow chart representing steps of one embodiment of the present invention. Although the steps represented in FIG. 3 are presented in a specific order, the present invention encompasses variations in the order of steps. Furthermore, additional steps may be executed between the steps illustrated in FIG. 3 without departing from the scope of the present invention.

Placement information for thick oxide 12, 14, 16, low-doped p-type single crystal silicon 4, and n-type silicon 6, 18, 20 is gathered 56 from the layout design 2. The n-type silicon 6, 18, 20 may include an n-type well 6, an n-type source 18, or an n-type drain 20. In one embodiment, size information for thick oxide 12, 14, 16 and n-type silicon 6, 18, 20 is gathered 58 from the layout design 2.

Thick oxide overlaying low-doped p-type single crystal silicon and abutting n-type silicon is identified 60 in the layout design 2. In one embodiment, identifying 60 thick oxide includes identifying 60 thick oxide larger than the abutting n-type silicon by a determined amount. In an alternative embodiment, identifying 60 thick oxide includes identifying 60 thick oxide abutting two or more n-type regions.

The user is alerted 62 of the identified areas of thick oxide. In one embodiment, alerting 62 the user includes displaying placement information of the identified thick oxide on a display device. For example, the user may be alerted by displaying coordinates of the identified thick oxide on display device 52.

In an alternative embodiment, alerting 62 the user includes displaying a visual representation of the layout design on a display device and marking on the visual representation the identified areas of thick oxide. For example, the user may be alerted by displaying a visual representation of layout design 2, and marking on the visual representation the identified areas of thick oxide.

The foregoing description is only illustrative of the invention. Various alternatives, modifications, and variances can be devised by those skilled in the art without departing from the invention. Accordingly, the present invention embraces all such alternatives, modifications, and variances that fall within the scope of the described invention.

What is claimed is:

1. A method for alerting a user of a design analyzer of areas in a semiconductor layout design that may be candidates for radiation induced inversion, the method comprising:
gathering, from the layout design, placement information for thick oxide, low-doped p-type single crystal silicon, and n-type silicon;
identifying, in the layout design, thick oxide overlaying low-doped p-type single crystal silicon and abutting n-type silicon; and
alerting the user of the identified areas of thick oxide.

2. The method of claim 1 wherein the n-type silicon includes an n-type well.

3. The method of claim 1 wherein the n-type silicon includes an n-type source.

4. The method of claim 1 wherein the n-type silicon includes an n-type drain.

5. The method of claim 1 wherein identifying thick oxide overlaying low-doped p-type single crystal silicon and abutting n-type silicon further includes identifying thick oxide abutting two or more n-type regions.

6. The method of claim 1 further including gathering, from the layout design, size information for thick oxide and n-type silicon and wherein the size of the identified thick oxide is larger than the abutting n-type silicon by a determined amount.

7. The method of claim 1 wherein alerting the user includes displaying placement information of the identified thick oxide.

8. The method of claim 1 wherein alerting the user includes:
displaying a visual representation of the layout design and
marking on the visual representation the identified areas of thick oxide.

9. A program storage system readable by a computer, tangibly embodying a program, applet, or instructions executable by the computer to perform method steps for alerting a user of the computer of areas in a semiconductor layout design that may be candidates for radiation induced inversion, the method comprising:
gathering, from the layout design, placement information for thick oxide, low-doped p-type single crystal silicon, and n-type silicon;
identifying, in the layout design, thick oxide overlaying low-doped p-type single crystal silicon and abutting n-type silicon; and
alerting the user of the identified areas of thick oxide.

10. The program storage system of claim 9 wherein the n-type silicon includes an n-type well.

11. The program storage system of claim 9 wherein the n-type silicon includes an n-type source.

12. The program storage system of claim 9 wherein the n-type silicon includes an n-type drain.

13. The program storage system of claim 9 wherein identifying thick oxide overlaying low-doped p-type single crystal silicon and abutting n-type silicon further includes identifying thick oxide abutting two or more n-type regions.

14. The program storage system of claim 9 further including gathering, from the layout design, size information for thick oxide and n-type silicon and wherein the size of the identified thick oxide is larger than the abutting n-type silicon by a determined amount.

15. The program storage system of claim 9 wherein alerting the user includes:
displaying a visual representation of the layout design and
marking on the visual representation the identified areas of thick oxide.

16. The program storage system of claim 9 wherein alerting the user includes displaying placement information of the identified thick oxide.

17. A semiconductor layout design analyzer for alerting a user of areas in a semiconductor layout design that may be candidates for radiation induced inversion, the analyzer comprising:
means for gathering, from the layout design, placement information for thick oxide, low-doped p-type single crystal silicon, and n-type silicon;
means for identifying, in the layout design, thick oxide overlaying low-doped p-type single crystal silicon and abutting n-type silicon; and
means for alerting the user of the identified areas of thick oxide.

18. The analyzer of claim 17 wherein the n-type silicon includes an n-type well.

19. The analyzer of claim 17 wherein the n-type silicon includes an n-type source.

20. The analyzer of claim 17 wherein the n-type silicon includes an n-type drain.

21. The analyzer of claim 17 wherein the means for identifying includes means for identifying thick oxide abutting two or more n-type regions.

22. The analyzer of claim 17 wherein:
the means for gathering includes means for gathering, from the layout design, size information for thick oxide and n-type silicon and
the size of the identified thick oxide is larger than the abutting n-type silicon by a determined amount.

23. The analyzer of claim 17 wherein the means for alerting the user includes:
a display device;
means for displaying, on the display device, placement information of the identified thick oxide.

24. The analyzer of claim 17 wherein alerting the user includes:
a display device;
means for displaying, on the display device, a visual representation of the layout design; and
means for marking on the visual representation the identified areas of thick oxide.
